(19) United States
(12) Patent Application Publication
(10) Pub. No.: US 2002/0047019 A1
(43) Pub. Date: Apr. 25, 2002

(54) PILL DISPENSING APPARATUS

(76) Inventor: JAMES DEVERS, YPSILANTI, MI (US)

Correspondence Address: ERNEST I GIFFORD, GIFFORD KRASS GROH SPRINKLE, ANDERSON & CITKOWSKI P C, 280 N OLD WOODWARD AVE SUITE 400, BIRMINGHAM, MI, 48009

(21) Appl. No.: 09/382,369

(22) Filed: Aug. 24, 1999

(51) Int. Cl. G07F 11/00

(52) U.S. Cl. 221/2

(57) ABSTRACT

An electronic pill dispenser that includes two receptacles, one of which is easily accessible, is programmed as to when respective medications should be dispensed. The pill dispenser processes this programmed information, and effects the distribution of appropriate pills at appropriate times by actuating one or more DC motors mechanically connected to rotate wheels within which pills are housed. Upon dispensing pills, the present invention announces what it has done by way of speaker. Alternative embodiments of the present invention may include voice-activation and recognition, and may be capable of connecting to a personal computer for the purposes of programming.

### FIELD OF THE INVENTION

This invention relates to pill dispensing apparatus, and more particularly, to an electronic system for selectively dispensing many different types of pills and notifying a patient at appropriate times.

### BACKGROUND OF INVENTION

Elderly individuals and those with serious ailments are often required to ingest several doses of a number of different medications each day. These medications are often distributed in pill or capsule form, allowing the patient to ingest the medication orally so as to enter the patient's bloodstream upon digestion.

Some of the same individuals who must take several medications regularly, are likely to forget to take each of their medications at the prescribed times because of their age or illness. Other patients may be under the care of a nurse in a hospital or nursing home who is responsible for a multitude of patients, each with a specific regimen of several medications. Therefore, it is difficult to manage the dispensing of pills and capsules. It has been estimated that as much as 18% of medication errors occur because the patient takes, or is given, a medication improperly, or fails to take an appropriate medication.

A variety of arrangements have been devised in an effort to simplify the process but, in almost all instances, such equipment becomes complex to use or is costly to acquire. For example, the device disclosed in U.S. Pat. No. 5,310,082 issued to Coustenoble utilizes an optical sensor and a processor's random access memory to track the distribution of pills. Other equipment requires that pills be placed in a specific fashion each day, so as to allow the device to dispense the pills at the appropriate times of that particular day.

It is thus an object of the invention to provide apparatus for the management of dispensing pills and capsules which signals the time for administration of the medications and identifies the location of the medication in the apparatus.

It is a further object of this invention to provide an electronic system for dispensing apparatus which will allow a person dispensing pills to simply determine the dispensing cycle

It is a still object of this invention to provide an electronic dispensing apparatus which allows the person taking the pills to determine the dispensing cycle.

### SUMMARY OF THE INVENTION

These and other objects are accomplished by providing an electronic pill dispenser. The pill dispenser of the present invention has a number of wheels, preferably 1-12, each with a number of cavities, preferably 8-16, in which pills can be stored and from which the pills can be ultimately individually dispensed. One or more doses of a particular medication may be placed in each of a number of cavities of a wheel prior to use. It is also contemplated that a user may place a number of medications or vitamins in a specified cavity and take from that cavity at the same time. The appropriate dose of each medication is then released onto a tray at appropriate programmed times. The dispensing of the pills is accomplished by means of one or more DC motors, drivingly connected to the wheels. The pill dispenser is programmed by means of a keypad or voice recognition. The commands given by the programmer are processed by a microprocessor, and the microprocessor subsequently uses these commands to control the operation of the pill dispenser. A visual display, such as an LCD display, is provided so as to allow the programmer of the pill dispenser to receive feedback in response to his commands, such feedback typically relating to programming and status of the pill dispenser. Additionally, a speaker is provided to alert the patient when it is appropriate to ingest one or a group of pills which have been dispensed.

### BRIEF DESCRIPTION OF DRAWINGS

A better understanding of the present invention will be apparent upon reference to the following drawings in which:

FIG. 1 is an elevated side view of a preferred embodiment of the present invention;

FIG. 2 is a cross-sectional view taken along line 2-2 in FIG. 1;

FIG. 3 is a cross-sectional view taken along line 3-3 in FIG. 2; and

FIG. 4 is a schematic drawing of the circuit utilized by a preferred embodiment of the present invention.

### DETAILED DESCRIPTION OF THE PREFERRED EMBODIMENT

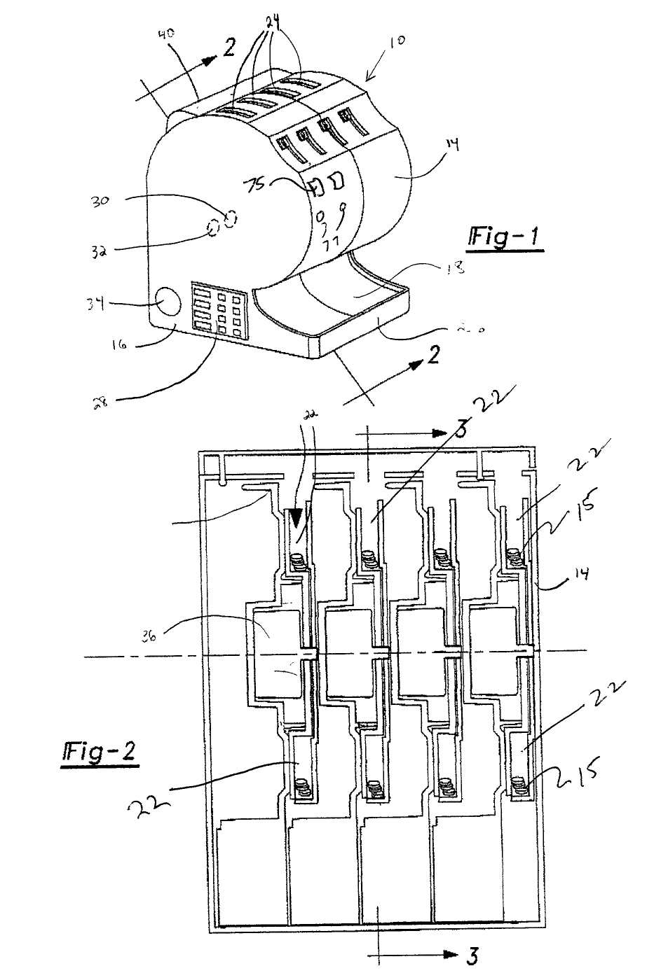

Referring first to FIG. 1, an automatic pill dispensing according to the present invention is thereshown. The apparatus includes a housing 10 having a cylindrical portion 14 supported on a base 16, so that the axis of the cylindrical portion 14 is generally horizontal.

Wheels 12 (FIG. 2) situated inside of the cylindrical portion 14 so they can rotate. In order to gain access to the wheels 12, access opening 24 are provided on the top of the cylindrical portion 14.

A pill receiving tray 18 is also provided below the cylindrical portion 14. When a pill is dispensed, it is dropped into the pill receiving tray 18. In order to prevent any pills from inadvertently falling out of the pill receiving tray 18 upon being dispensed, a tray retaining wall 26 is provided.

Additionally, a display and program pad 28 is provided on one side of the housing 10. The operation of the display and program pad 28 is described in more detail below.

An AC adapter plug 32 of a type well known to those skilled in the art is also provided on a side of the housing 10. The AC adapter plug 32 allows the present invention to be powered by alternating current of a voltage common to most households through the use of an AC adapter of a type well known to those skilled in the art.

In the preferred embodiment of the present invention, a computer interface plug 30, described in more detail below, is provided on the housing 10. By means of the computer interface plug 30, a computer may be linked to the present invention so as to allow various programming and feedback functions to be performed through the computer.

One or more speakers 34 are also provided. Upon dispensing a pill, the present invention notifies the patient or care provider with an auditory signal from the speaker 34.

Referring now to FIG. 2, a cross section of the present invention is thereshown. The preferred embodiment has a number of wheels 12 preferably up to 12, the accompanying illustrations being shown an embodiment with four wheels. However, it will be obvious from this disclosure to anyone skilled in the art, that fewer or a greater number of wheels 12 may be used, and that there are advantages and disadvantages associated with increasing or decreasing the number of wheels 12 utilized.

Each wheel 12 has a number of cavities 22 which can be in a range of between 8-32. Before being dispensed, pills 15 are stored in these cavities 22. The preferred embodiment of the present invention has eight cavities 22 disposed in each wheel 12. In a desired embodiment, the machine includes four wheels 12, each with eight cavities 22. This would permit a user to dispense groups of medicines from each cavity 22, and the cavities could be made considerably larger. This allows thirty-two doses of a particular medication to be dispensed before refilling the apparatus becomes necessary, enough to last over a month for a medication taken once daily. In the preferred embodiment, the edges of the wheels 12 are rounded so as to avoid individual pills getting stuck partially in a cavity 22 and subsequently obstructing the rotation of the wheel 12.

A DC motor 36 is drivingly engaged with each wheel 12. The dispensing of the pills 15 is effected by rotation of the wheels 12 by the DC motors 36. The DC motors 36 are controlled by a microprocessor, as is described in more detail below.

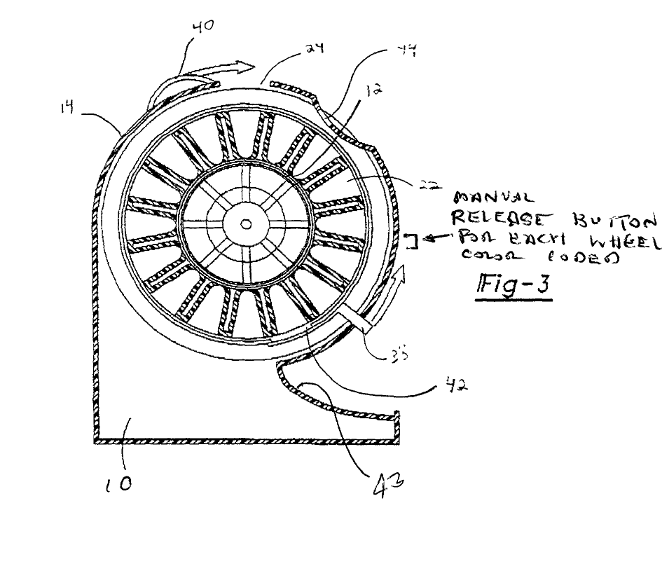

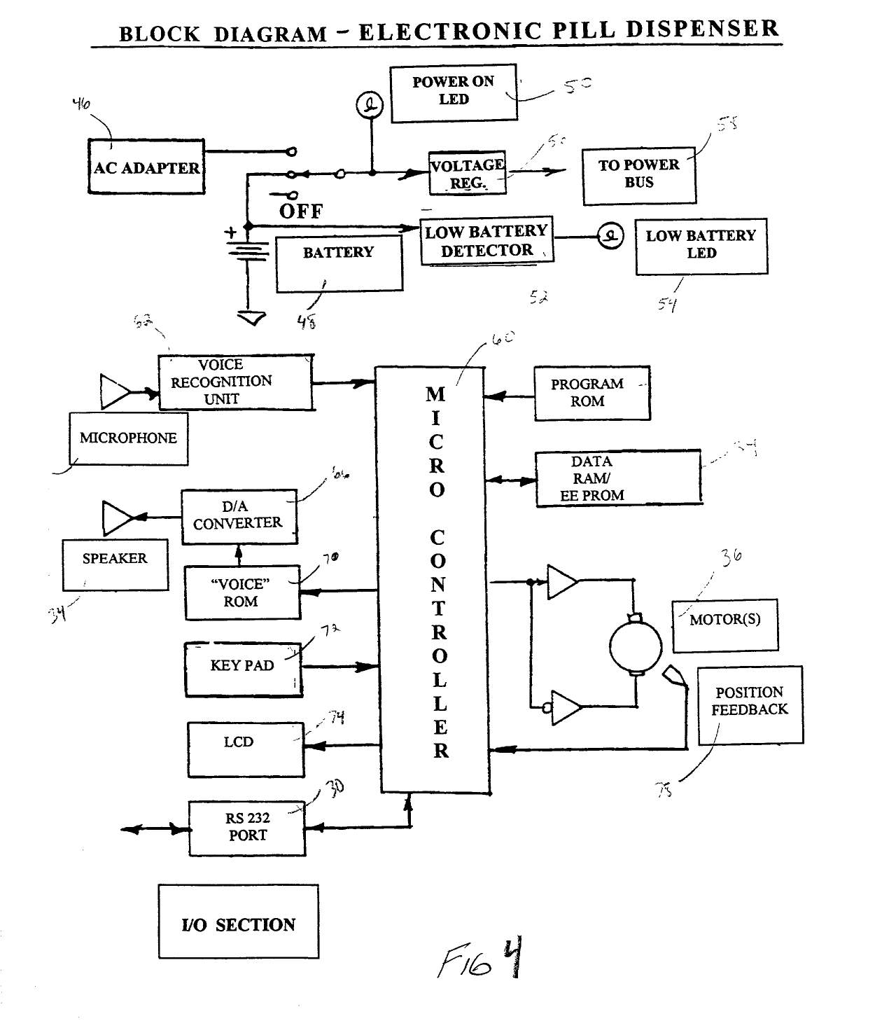

With reference now to FIG. 3, a further cross section of the present invention is thereshown. A top sliding cover 40 is provided on the top of the cylindrical portion 14. When it is desired to fill the pill dispenser with pills 15, the sliding cover 40 is moved to a position such that the access openings 24 are open and accessible. In contrast, the sliding cover 40 is moved to a position covering the access openings 24 during normal use.

Similarly to the access openings 24, a dispensing passage 42 is provided, through which the pills 15 being dispensed are dropped. The dispensing passage 42 is of a substantially similar width to that of the cavities 22. While refilling the pill dispenser, a bottom sliding cover 38 covers the underside of the dispensing passage 42. This bottom sliding cover 38 prevents any pills from falling out of the pill dispenser while it is being refilled. In order for the pill dispenser of the present invention to function as intended, however, the bottom sliding cover 38 must be moved such that it does not obstruct pills 15 from being dispensed.

A refill rotation opening 44 is also provided in the cylindrical portion 14. When refilling the pill dispenser, the user can manually rotate the wheels 12. Therefore, pills 15 can inserted into any of the cavities 22. Though not illustrated, upon the outer edge of each cavity 22 is displayed a number corresponding to that particular cavity 22. This number may also be displayed in braille for patients who cannot see well. Thus the user of the pill dispenser can be assured as to what will be dispensed upon operation.

In an alternate variant, the indicator illustrated in FIG. 3 at 43 is removed and the bottom sliding cover 38 remains in the closed position during refilling. In this manner, each of the wheels are incrementally advanced one detent and progressively filled. When completely refilled, the machine is switched off refill mode.

With reference finally to FIG. 4, a schematic illustration of the electronic system utilized for the operation of the pill dispenser of the present invention is thereshown. The electronic circuitry of the present invention may be powered by a battery 48, or alternatively may be powered by an AC adapter 46 plugged into a convention wall socket as is well known to those skilled in the art. The battery 48 is disconnected from the rest of the circuitry when an AC adapter 46 is used. A power LED 50 is provided. The power LED 50 illuminates when power is being provided to the circuitry of the present invention.

Means for detecting the charge of a battery, the low battery detector 52, is also provided. When the battery 48 has below a predetermined charge, the low battery LED 54 is illuminated, indicating to the operator that the battery 48 should be charged or an AC adapter 46 should be used.

The potential of the power provided to the circuitry of the present invention is controlled by a voltage regulator 56 of a type well known to those skilled in the art. The voltage is regulated to prevent any damage to any of the circuit elements utilized by the present invention. Once the voltage has been checked, and corrected if necessary, the power is supplied to the circuitry via the power bus 58.

The microprocessor 60 of a type well known to those skilled in the art is provided, and controls all of the major functions of the pill dispenser. The microprocessor 60 processes the programmed information inputted by the user, directs the dispensing of the appropriate pills, and notifies the operator of the status of the present invention.

Information, instructions, and programming can be entered by means of a key pad 72. This information is then processed and handled accordingly by the microprocessor 60. Alternatively, a microphone 64 can be used in conjunction with a voice recognition unit 62 to input information, instructions, and programming. This information from the microphone 64 and voice recognition unit 62 is handled in a similar manner to that from the key pad 72.

In residential or multiple patient care facilities, it may be useful to allow the transfer of patient medication schedule data directly from a computer to the microprocessor 60. An RS-232 port 30 is provided for this purpose. In addition, all information that can be entered to the microprocessor 60 through the use of either the key pad 72 or microphone 64 and voice recognition unit 62, can be entered using a computer in conjunction with the RS-232 port 30. The use of the RS-232 port 30 extends the benefits of the device to multiple users.

The purpose of being more “user friendly” an LCD 74, of a type well known to those skilled in the art, is also provided. When appropriate, the microprocessor 60 uses the LCD 74 to provide the user feedback regarding programming and the status of the pill dispenser. Additionally, the LCD 74 can be used to display the date and time, as well as a message to the patient reminding him to take his medication.

A window 75 may also be positioned on the outside of each wheel 12, (see FIG. 1), the window illustrating a date and a medication and whether or not the dosage has been taken. The operation window illustration can be powered by the microprocessor 60 and would include such indicia as, for example, “Aug. 28, “M” for morning, “N” for noon, “E” for evening, “T” for taken and “U” for untaken. In this variation, a push button 77 (see again FIG. 1) is utilized rather than the microprocessor dispensing the pills. The button may be color-coded for easy recognition and, if the pills remain untaken, the window in front of each will record that.

A speaker 34 may also be utilized for this purpose. In the preferred embodiment of the present invention, the microprocessor 60 stores various auditory messages in memory by the voice ROM 70. In order to remind the patient to take a particular medication which has been dispensed, or to notify the user of the status or programming of the pill dispenser, a sequence of auditory signals stored in the voice ROM 70 are converted from memory to audio by the D/A converter 66, and then sounded by the speaker 34. By means of these devices, the present invention can, at appropriate times, tell the patient in a human voice, that it is time for him to ingest a pill that has just been dispensed. This feature is especially useful for those patients with limited or no eyesight.

The microprocessor 60 also controls the operation of the DC motors 36. When it is appropriate to dispense a particular medication from one of the wheels 36 for a short period of time to effect the rotation of the respective wheel 12. In this manner, the microprocessor 60 can control what medications are dispensed and when they are dispensed.

The microprocessor 60 receives feedback regarding the position of the wheels 12 from the position feedback sensor 78. The position feedback sensor 78 can be of any type well known to those skilled in the art, such as a pitch sensor.

The microprocessor 60 determines what it is to do from the information it receives from the program ROM 82 and the data RAM 84. The program ROM 82 is the collection of all of the instructions set forth by the user in his programming of the present invention. The data RAM 84 is the collection of all other information that the present invention utilizes, i.e. the date, time, positions of the wheels 12 etc. Besides using the information provided by the data RAM 84, the microprocessor 60 also updates the data RAM 84 as to the status of the pill dispenser.

Having described my invention, however, many modifications thereto will become apparent to those skilled in the art which it pertains without deviation from the spirit of the invention as defined by the scope of the appended claims.

I claim:

1. An apparatus for storing and dispensing pills comprising:
a first hollow receptacle;
said pills being contained within compartments within the hollow interior of said first receptacle;
said first hollow receptacle having at least one opening for said pills to be inserted, and at least one opening through which pills may be dispensed;
a second receptacle to which said pills are dispensed;
means for transporting said pills from said first receptacle to said second receptacle.

2. The apparatus of claim 1 wherein said means for transporting said pills comprises:
at least on wheel;
said wheel having a number of cavities for storing said pills ranging between 8-32;
at least one motor;
said motor being in electrical communication with a processor.

3. The apparatus of claim 2 further comprising means for determining the rotational position of said wheel, said means for determining the rotational position of said wheel being in electrical communication with said processor.

4. The apparatus of claim 2 wherein said first receptacle further has a third opening through which said wheel can be manually rotated.

5. The apparatus of claim 1 further comprising means for displaying the status of said apparatus.

6. The apparatus of claim 1 further comprising means for being connected, so as to be in electrical communication, with a personal computer.

7. The apparatus as defined in claim 1 and including:
means for tracking the passage of time;
power means;
means for being programmed as to when to distribute particular pills, and
means for announcing that said particular pills have been dispensed.

8. The apparatus of claim 7 wherein said means for being programmed comprises:
a microphone;
a voice recognition unit;
said voice recognition unit being in electrical communication with a processor

9. The apparatus of claim 7 wherein said power means comprises a battery.

10. The apparatus of claim 7 wherein said power means comprises an AC adapter electrically connected to a wall socket.

11. The apparatus of claim 7 wherein said means for being programmed comprises a key pad in electrical communication with a processor.
